(19) United States
(12) Patent Application Publication
(10) Pub. No.: US 2010/0320933 A1
(43) Pub. Date: Dec. 23, 2010

(54) ILLUMINATION DEVICE

(75) Inventor: CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/713,315

(22) Filed: Feb. 26, 2010

(30) Foreign Application Priority Data
Jun. 18, 2009 (CN) 200910303406.6

(51) Int. Cl. H05B 37/02

(52) U.S. Cl. 315/294

(57) ABSTRACT

An illumination device for illuminating a road includes a light source, a solar cell module, a sensor and a control module. The light source includes a plurality of light emitting elements and an optical element. Light generated from the light emitting elements passes through the optical element and is emitted from the illumination device at a half-intensity angle of between −20° and 20° with respect to a road surface. The solar cell module is electrically connected to the light emitting elements, and converts light directly into electricity. The sensor detects environmental brightness. The control module is electrically connected to the solar cell and the light emitting elements. The control module controls the current to the light emitting elements to adjust the brightness of the light emitting elements.

### BACKGROUND

1. Technical Field

The present disclosure relates to an illumination device, and particularly, to an illumination device providing road illumination.

2. Description of Related Art

In illumination technology, light pollution, such as light trespass, over-illumination, glare, light clutter, and sky glow are generally to be avoided. A single offending light source can fall into more than one of these categories. Among them, glare can be further categorized into direct glare and indirect glare.

As shown in FIG. 1, light sources 101 are located above the eye 102 of an observer. If an extended line passing through both the light source 101 and the eye 102 is at an angle of between 45 and 85° with respect to the vertical plane 103 passing the eye 102 of an observer, the light source 101 causes direct glare. The extended line is located within a half-intensity angle of the light source 101.

Streetlamps can cause direct glare to drivers. As shown in FIG. 2, light is emitted from a streetlamp 201 toward the road. The streetlamp 201 illuminates further along an X axis parallel to the road than the perpendicular Y axis. The light distribution of the streetlamp 201 is symmetrical about the streetlamp 201 along the X axis, such that one half-intensity side angle β1 and the opposite half-intensity side angle 132 have the same absolute value along the X axis. The half-intensity side angle β1 and the half-intensity side angle β2 can be referred to as half-peak side angles, included angles between a central axis perpendicular to the road surface and an illumination orientation of half maximum intensity. However, the half-intensity side angle β1 and the half-intensity side angle β2 are often equal to 75° and −75° respectively, such that the streetlamp 201 causes direct glare. FIG. 3 illustrates luminance distribution of the streetlamp 201, a point B corresponds to a light beam having maximum intensity between 0 and 90°, and the point A corresponds to a light beam of half of the maximum intensity between 0 and 90°. Measured from the point A to the central axis, the half-intensity side angle β of the streetlamp 201 is about 75°.

To prevent direct glare from the streetlamp 201, the absolute value of the half-intensity side angle β1 and the absolute value of the half-intensity side angle β2 should be less than 45° along the X axis. However, if the absolute value of the half-intensity side angles is decreased, the number of the streetlamps 201 must be increased commensurately in response to the smaller radiation angles, and therefore more power is consumed. Moreover, since the streetlamps are usually fixed on poles at a height of 4 meters, assembly and maintenance thereof can be difficult, more so with the increased number thereof.

Accordingly, it is desirable to provide an illumination device which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present image capture device and control method thereof. Moreover, in the drawings, like reference numerals designate corresponding parts throughout the views.

FIG. 1 is a schematic view of a glare effect in a commonly used streetlamp.

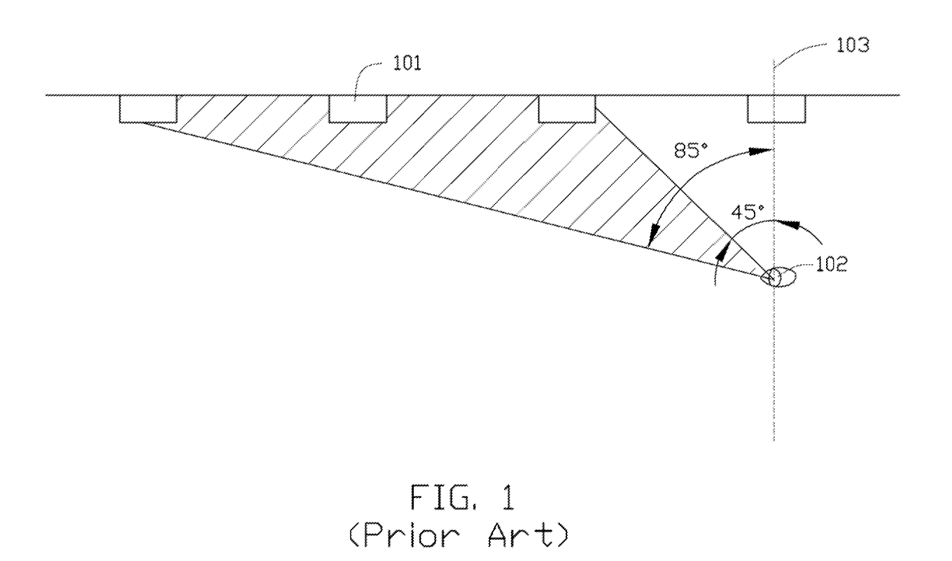

FIG. 2 is a schematic view of the illumination of the streetlamp of FIG. 1.

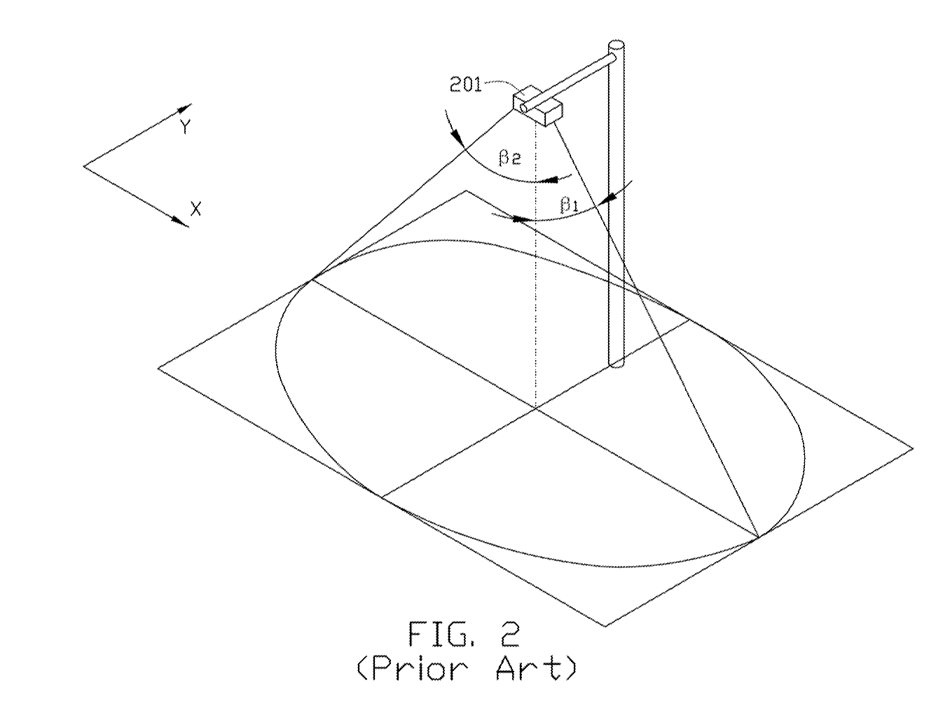

FIG. 3 is a schematic view of the luminance distribution of the streetlamp of FIG. 1.

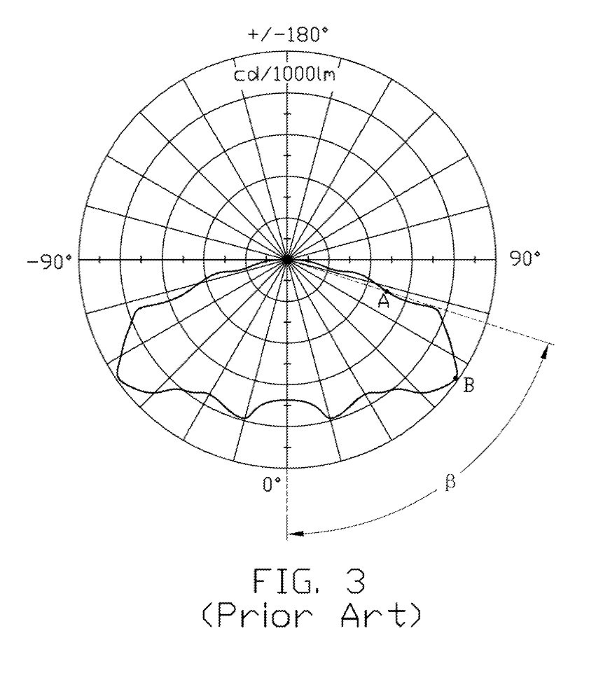

FIG. 4 is a block diagram illustrating an illumination device according to a first embodiment of the present disclosure.

FIG. 5 is a schematic view of the illumination device shown in FIG. 4.

FIG. 6 is a schematic cross section of the illumination device shown in FIG. 5.

FIG. 7 is a schematic view of the luminance distribution of the illumination device shown in FIG. 6.

FIG. 8 is a block diagram illustrating an illumination device according to a second embodiment of the present disclosure.

FIG. 9 is a schematic cross section of the illumination device shown in FIG. 8.

FIG. 10 is a schematic view of an optical lens shown in FIG. 9.

### DETAILED DESCRIPTION

Embodiments of the disclosure will now be described in detail with reference to the accompanying drawings.

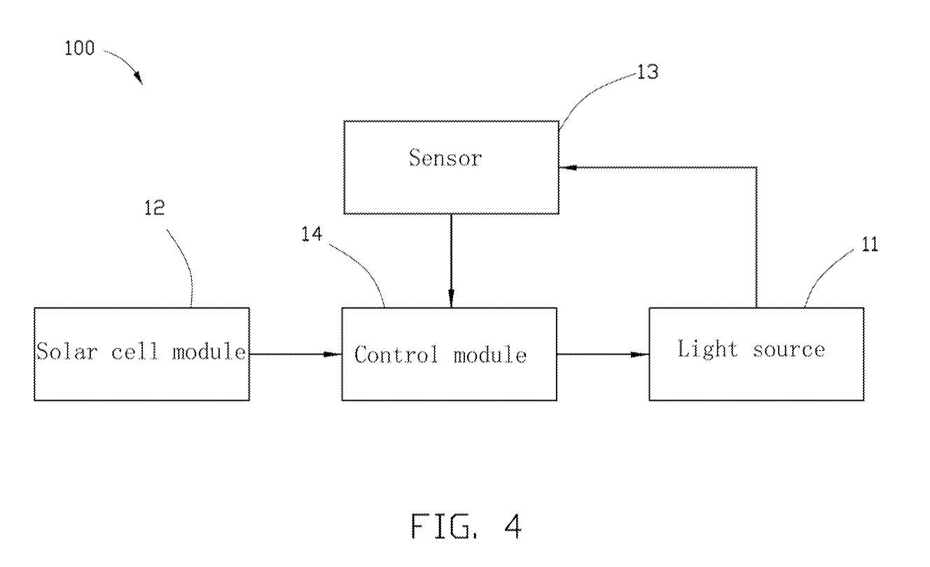

Referring to FIG. 4, a first embodiment of the present disclosure provides an illumination device 100. As shown in FIG. 4, the illumination device 100 includes a light source 11, a solar cell module 12, a sensor 13, and a control module 14.

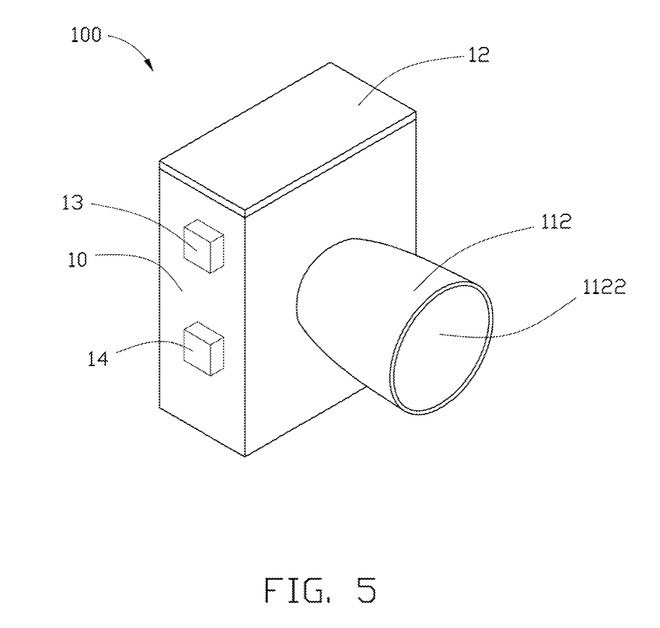

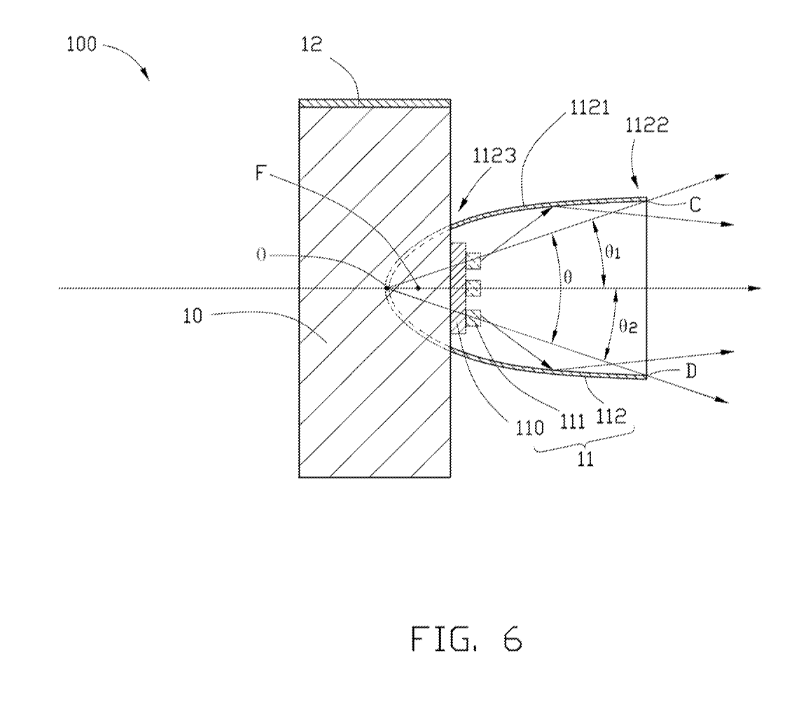

Referring to FIG. 5 and FIG. 6, the light source 11 is located on one side of a carrier 10 for road illumination. The light source 11 includes a substrate 110, a plurality of light emitting elements 111 located on the substrate 110, and a reflector 112. The substrate 110 supports the light emitting elements 11, and is substantially perpendicular to a road surface. For example, the substrate 110 may be a flat board. In application, the carrier 10 may be located beside a road, on a median in the middle of a road, or on a separation line in the middle of a road.

The light emitting elements 111 may be LEDs, LED chips, organic light emitting diodes (OLEDs) or any other light emitting units. It is noted that the number of light emitting elements 11 should not be limited to that disclosed, and may include a single light emitting element 111.

The reflector 112 may include a shell 1121 surrounding the light emitting elements 111, a first opening 1123 adjacent to the light emitting elements 111, and a second opening 1122 opposite to the first opening 1123. An inner surface of the shell 1121 is reflective to reflect the light generated from the light emitting elements 111 toward the second opening 1122. The inner surface of the shell of the reflector 112 is a symmetrical parabolic surface truncated by the first opening 1123 and the second opening 1122. Preferably, an origin point O of the parabolic surface and the light emitting elements 111 are located on the opposite sides of the corresponding focal point F of the parabolic surface. Accordingly, the substrate 110 and the origin point O are preferably located on the opposite sides of the focal point F.

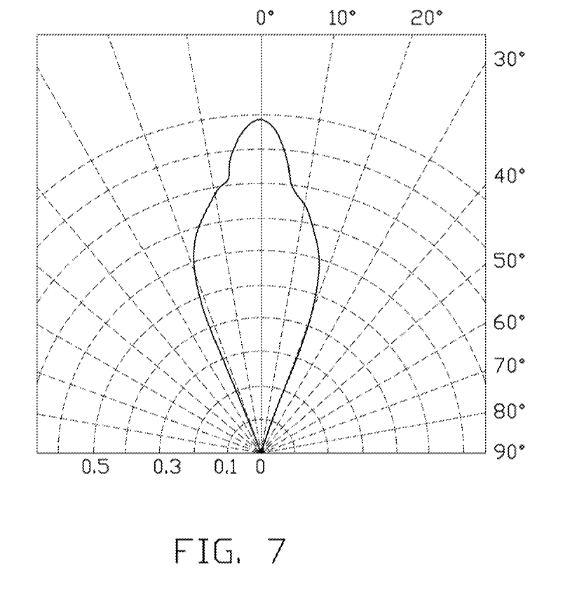

The second opening 1122 of the reflector 112 is circular. Two lines extending from the origin point O of the truncated parabolic surface to two terminals C and D of a diameter of the second opening 1122 have an included angle θ of 40° therebetween. Accordingly, the light generated by the light emitting elements 111 passes through the reflector 112 and is emitted from the illumination device 100 at a total half-intensity angle θ of between −20° and 20° with respect to a road surface which is parallel to a line extending through the origin point O and the focal point F, i.e., a central axis of the reflector 112. In other words, one half-intensity side angle θ1 is substantially about +20°; and the other half-intensity side angle θ2 is substantially about −20° in the present disclosure. For example, as shown in FIG. 7, the light of the light emitting elements 111 is emitted from the illumination device 100 at a total half-intensity angle θ of between −20° and 20° with respect to the road surface. The maximum intensity angle θ occurs at 0° in respect to the road surface, i.e., parallel to the road surface.

The solar cell module 12, located on the carrier 10, converts lights into electricity, and stores the electricity therein. The solar cell module 12 is electrically connected to the light source 11 to provide electricity to the light emitting elements 111 as required. The sensor 13 is an optical sensor configured at one side of the carrier 10 to determine the surrounding brightness. For the sensor 13, detected surrounding brightness is actually caused by all light radiating to the sensor 13, and in other words, may include the brightness of the light source 11 and the brightness of the environment. In response to the surrounding brightness, at least a corresponding detection signal occurs in the sensor 13.

The control module 14 is also located on the carrier 10, and is electrically connected to the solar cell module 12 and the light emitting elements 111. The detection signal is transferred form the sensor 13 to the control module 14. According to the detection signal (the detected surrounding brightness), the control module 14 controls the working current to the light emitting elements 111 so as to adjust the brightness of the light emitting elements 111 according to the detected surrounding brightness. Therefore, the surrounding brightness is modified by the illumination device 100 to be a predetermined surrounding brightness. In other embodiments, the control module 14 may be located on other positions, such as located on the substrate 110.

If the brightness of the environment is equal to or larger than the required surrounding brightness, the control module 14 provides a minimum working current to the light emitting elements 111. Preferably, if the brightness of the environment is equal to or larger than the predetermined surrounding brightness, the light emitting elements 111 are turned off for energy saving.

According to the above-mentioned illumination device 100, some light of the light emitting elements 111 may be reflected by the shell 1121 of the reflector 112; and most light of the light emitting elements 111 are emitted from the second opening 1122 of the illumination device 100 at the total half-intensity angle of between −20° and 20° with respect to the road surface. Since most light from the light emitting elements 111 is emitted from the illumination device 100 within a small angle range, a direct glare is effectively decreased. In addition, since the illumination device 100 can convert the surrounding light into electric potential energy, and provides the electric potential energy from the solar cell module 12 to the light emitting elements 111, less additional electric power is used. Furthermore, because the brightness of the light emitting elements 111 can be adjusted according to the ambient light, the illumination device 100 conserves energy.

In application of road illumination, the illumination device 100 can effectively avoid the direct glare. Although the light generated from the light emitting elements 111 may still reach eyes of observers in the distance, direct glare is likely avoided

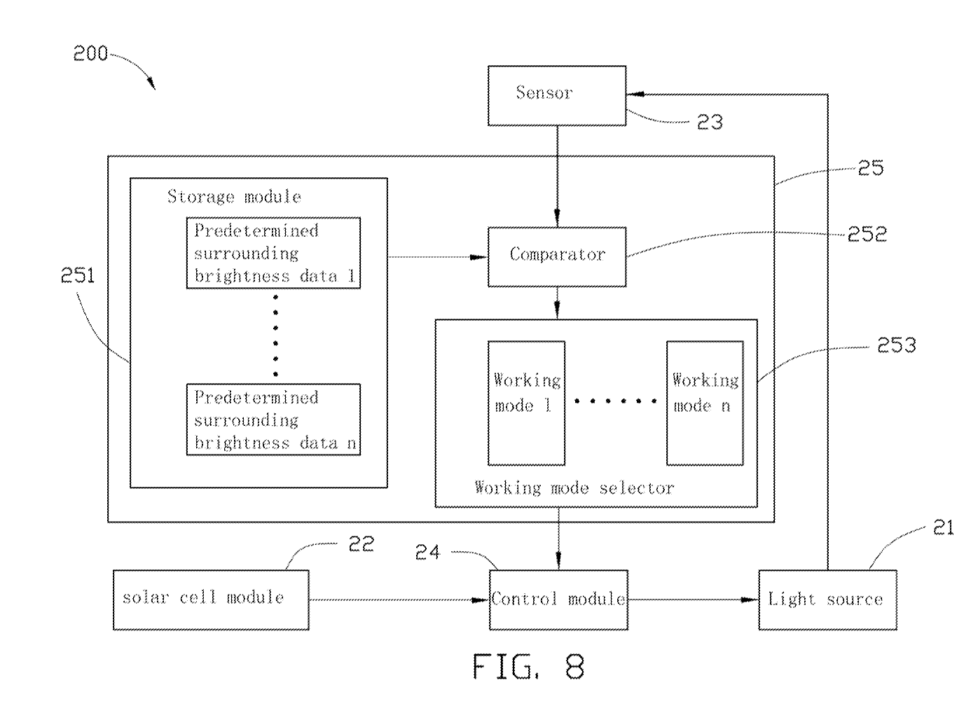

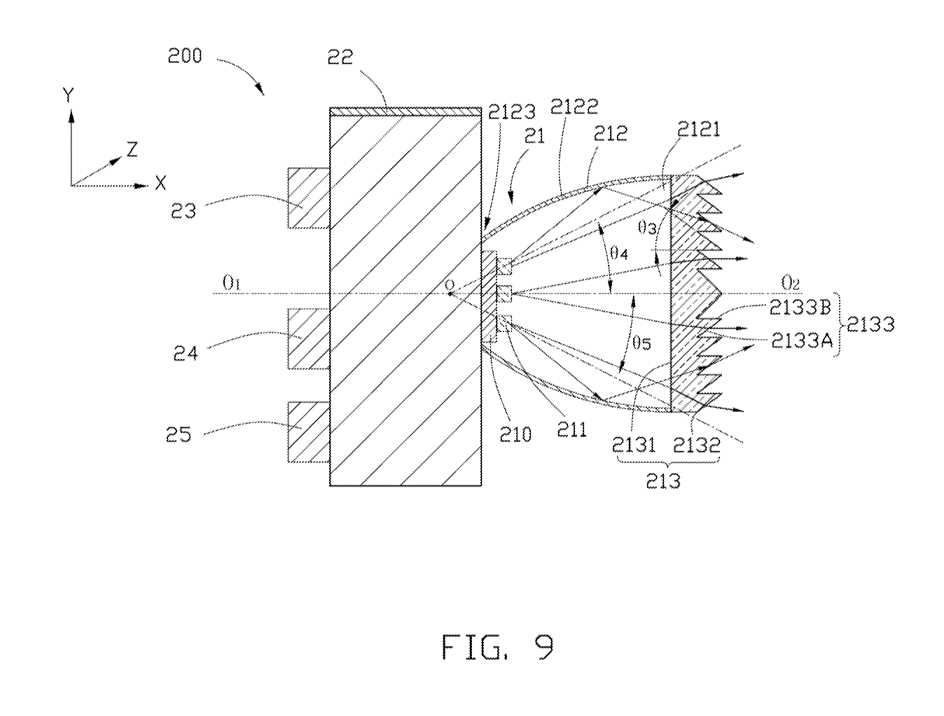

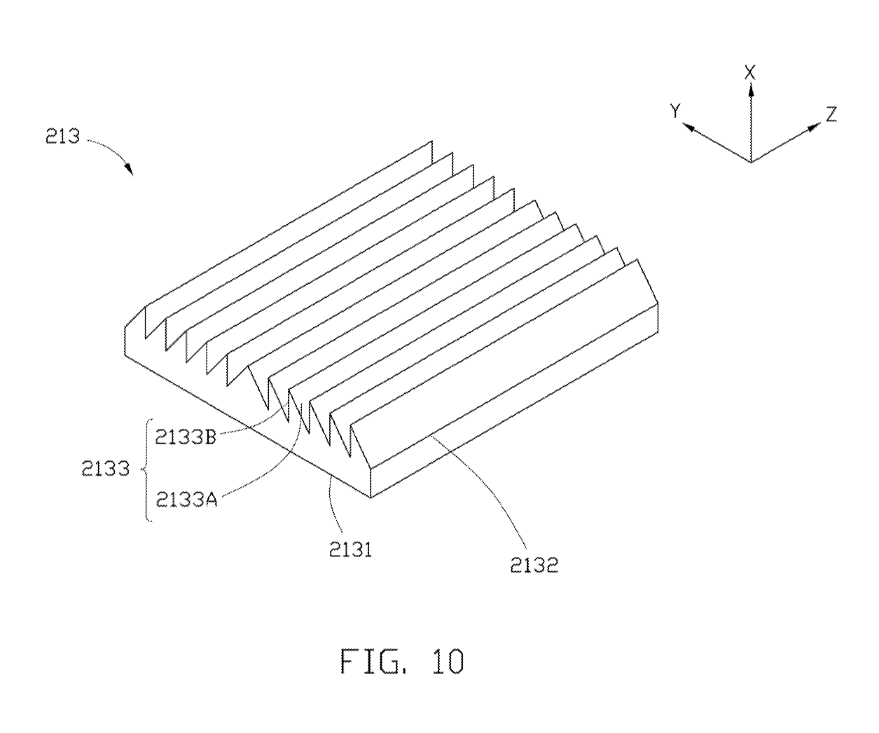

Please refer to FIG. 8 through FIG. 10. FIG. 8 is a block diagram illustrating an illumination device 200 according to a second embodiment of the present disclosure; FIG. 9 is a schematic view of the illumination device 200 shown in FIG. 8; and FIG. 10 is a schematic view of an optical lens shown in FIG. 9. As shown in FIG. 8, the illumination device 200 also includes a light source 21, a solar cell module 22, a sensor 23 and a control module 24.

The difference between the second embodiment and the first embodiment is that the illumination device 200 further includes a processor 25, and the light source 21 further includes an optic lens 213.

The processor 25 is electrically connected to sensor 23 and control module 24. The processor 25 includes a storage module 251, a comparator 252 and a working mode selector 253. The storage module 251 stores n predetermined surrounding brightness data, where n is a natural number.

The comparator 252 can compare the detection signal from the sensor 23 and the predetermined surrounding brightness data from the storage module 251, to provide a required brightness signal for the light emitting elements 211. The working mode selector 253 stores n working modes therein. Each working mode includes a required brightness datum of the light emitting elements 211 and a required working current value corresponding to the required brightness datum. In response to the required brightness signal sent from the comparator 252, the working mode selector 253 selects one of the working modes, so the required working current value is determined. According to the selected working mode, the control module 14 controls the working current applied from the solar cell module 22 to the light emitting elements 111, so as to adjust the brightness of the light emitting elements 111 according to the detected surrounding brightness. Therefore, the surrounding brightness is modified by the illumination device 200 to be a predetermined surrounding brightness.

As shown in FIG. 9, the light source 21 is applied to road illumination. An extended direction X is parallel to the road surface, and an extended direction Y is perpendicular the extended direction X. The light source 21 includes a substrate 210, a plurality of light emitting elements 211 located on the substrate 210, a reflector 212 and an optic lens 213. The substrate 210 is substantially parallel to the extended direction Y. In other words, the substrate 210 is substantially perpendicular to the road surface. The reflector 212 includes a shell 2122, a first opening 2123, and a second opening 2121.

The optic lens 213 is located at the second opening 2121 of the reflector 212. The optic lens 213 includes a light incident surface 2131 facing the light emitting element 211, a light emitting surface 2132 opposite to the light incident surface 2131, and a plurality of micro-structures 2133 located on the light emitting surface 2132. The light incident surface 2131 of the optic lens is a plane. The micro-structures 2133 focus the light from the light emitting element 211 in the extended direction Y.

Referring to both FIG. 9 and FIG. 10 particularly, the micro-structures 2133 are a plurality of prism units. The optic lens 213 having the micro-structures 2133 is symmetrical to a symmetry plane O1O2, and the symmetry plane O1O2 is substantially parallel to the extended direction X and the road surface. A central axis of the reflector 212 and a central axis of the optic lens 213 are coincidental with each other and on the symmetric plane O1O2.

Each prism unit includes a first plane 2133A and a second plane 2133B connecting the first plane 2133A. The first plane 2133A and the second plane 2133B of each prism unit have an acute angle θ3. Preferably, the acute angle θ3 is equal to or less than 33°. The second planes 2133B of the prism units are perpendicular to the light incident surface 2131 of the optic lens 213.

With regard to the micro-structures 2133 located at the same side of the symmetry plane O1O2, the second plane 2133B of each micro-structure 2133 is engaged with the first plane 2133A of the adjacent micro-structure 2133. Thus, the micro-structures 2133 located at the two sides of the symmetry plane O1O2 forms two sawtooth-like arrays respectively. At the symmetry plane O1O2, the second planes 2133B of two adjacent micro-structures 2133 located at the two opposite sides of the symmetry plane O1O2 are engaged with each other and converge away from the incident surface 2131.

Light from the light emitting elements 211 is refracted and focused by the optic lens 213, and a converging light distribution is formed. Specifically speaking, since the first plane 2133A and the second plane 2133B of each prism unit have an acute angle θ3 equal to or less than 33°, the full width half maximum (FWHM) of the illumination device 200 is distributed between −20° to 20° or less. The light running through the optic lens 213 is directly from the light emitting elements 211 or reflected by an inner surface of the shell 2122 of the reflector 212, in which the inner surface is a symmetrical ecliptic surface truncated by the first opening 2123 and the second opening 2121. More preferably, the half-intensity side angle θ4 and the half-intensity side angle θ5 are substantially equal 15° and −15°, respectively, and an FWHM of the illumination device 200 between −10° to 10° is the most preferred in the present disclosure in consideration of glare effect.

Since most light generated from the light emitting elements 211 is within a small angle range from −20° to 20° with respect to a road surface, direct glare is effectively decreased. Since the processor 25 can select one of the working modes according to the detection signal from the sensor 23 and control the working current to the light emitting elements 211, brightness of the illumination device 200 utilized is appropriate and power consumption is minimized. Moreover, since the solar cell module 12 can convert the surrounding light into electric potential energy, less additional power is needed.

In other embodiments, the optic lens 213 may applied to the first embodiment and located at the second opening 1122 of the reflector 112. In such a case, the light generated from light emitting elements 211 is further focused, so the glare effect is avoided.

As with all of the illumination devices of the present disclosure, variations are possible and the figures described herein are by way of example and not limitation. Variations, even significant, to the illumination device elements, as is well known to those of average skill in this art, do not alter the spirit of the present disclosure. For example, positions of the solar cell module, the sensor and the control module may be adjusted in other embodiments.

It is to be understood, however, that even though numerous characteristics and advantages of various embodiments have been set forth in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. An illumination device providing road illumination of a road having a road surface, comprising:
a light source, comprising at least one light emitting element and an optical element, wherein light generated from the at least one light emitting element passes through the optical element and is emitted from the illumination device at a half-intensity angle of between −20° and 20° with respect to the road surface, in which a central axis of the optical element is parallel to the road surface;
a solar cell module, electrically connected to the at least one light emitting element and converting surrounding light into electricity;
a sensor, configured to detect a surrounding brightness;
a control module, electrically connected to the solar cell module and the at least one light emitting element, wherein the control module controls a current to the at least one light emitting element to adjust the brightness of the at least one light emitting element according to the surrounding brightness.

2. The illumination device of claim 1, wherein the light source further comprises a substrate supporting the at least one light emitting element, the substrate being perpendicular to the road surface.

3. The illumination device of claim 1, wherein the optical element comprises a reflector surrounding the at least one light emitting element.

4. The illumination device of claim 3, wherein the reflector comprises:
a shell surrounding the at least one light emitting element;
a first opening adjacent to the at least one light emitting element; and
a second opening opposite to the first opening.

5. The illumination device of claim 4, wherein the shell comprises an inner surface reflecting the light from the at least one light emitting element toward the second opening.

6. The illumination device of claim 5, wherein the inner surface of the shell of the reflector is a parabolic surface truncated by the first opening and the second opening.

7. The illumination device of claim 6, wherein an origin point of the parabolic surface and the at least one light emitting element are located on the opposite sides of a focal point of the parabolic surface.

8. The illumination device of claim 7, wherein the second opening of the reflector is circular with two lines extending from the origin point of the truncated parabolic surface to two terminals of a diameter of the circular opening forming an included angle of 40° between the two lines.

9. The illumination device of claim 4, wherein the optical element further comprises an optic lens located at the second opening of the reflector to focus the light generated from the at least one light emitting element.

10. The illumination device of claim 9, wherein the optic lens comprises:
a light incident surface facing the at least one light emitting element;
a light emitting surface opposite to the light incident surface, and
a plurality of micro-structures located on the light emitting surface to focus the light beam generated from the at least one light emitting element.

11. The illumination device of claim 10, wherein the micro-structures are a plurality of prism units, each comprising a first plane and a second plane connecting the first plane, and the first plane and the second plane of each of the prism units form an acute angle.

12. The illumination device of claim 10, wherein the light incident surface of the optic lens is a plane.

13. The illumination device of claim 12, wherein the second planes of the prism units are perpendicular to the light incident surface of the optic lens.

14. The illumination device of claim 1, further comprising a processor storing a plurality of working modes.

15. The illumination device of claim 14, wherein the sensor provides at least one detection signal to the processor regarding environmental brightness, the processor selects one of the working modes according to the detection signal, and the control module adjusts the brightness of the at least one light emitting element according to the working mode selected by the processor.

16. The illumination device of claim 15, wherein the processor comprises:
a storage module storing a plurality of predetermined surrounding brightness data;
a comparator comparing the detection signal from the sensor and the predetermined surrounding brightness data from the storage module, so as to provide a required brightness signal of the at least one light emitting element; and
a working mode selector storing the working modes, the working mode selector selecting one of the working modes according to the required brightness signal, each of the working modes comprising a required brightness datum of the at least one light emitting element and a required working current value corresponding to the required brightness datum.

17. The illumination device of claim 10, wherein the shell of the reflector has an inner surface reflecting the light generated from the at least one light emitting element toward the optic lens, the inner surface being an elliptical surface.
